(19) United States
(12) Patent Application Publication
(10) Pub. No.: US 2014/0178069 A1
(43) Pub. Date: Jun. 26, 2014

(54) OPTICAL RECEIVER MODULE

(71) Applicant: Electronics and Telecommunications Research Institute, Daejeon (KR)

(72) Inventors: Taeyong KIM, Daejeon (KR); JiHo JOO, Goyang (KR); Gyungock KIM, Daejeon (KR)

(21) Appl. No.: 13/940,212

(22) Filed: Jul. 11, 2013

(30) Foreign Application Priority Data
Dec. 21, 2012 (KR) 10-2012-0151056

(51) Int. Cl. H04J 14/02

(52) U.S. Cl. CPC H04J 14/0221
USPC 398/49

(57) ABSTRACT

An optical receiver module may include a demultiplexer routing a plurality of multiplexed optical signals to different optical paths depending on their wavelengths, a photodetector provided spaced apart from the demultiplexer to convert the optical signals into electric signals, respectively, a pre-amplifier electrically connected to the photodetector to amplify intensities of the electric signals, a flexible printed circuit board including a first electrode layer, which is electrically connected to the pre-amplifier to transmit the electric signals to the external circuit, and a second electrode layer configured to supply a ground potential. The flexible printed circuit board are provided not to have any via hole between the first and second electrode layers.

### CROSS-REFERENCE TO RELATED APPLICATIONS

This U.S. non-provisional patent application claims priority under 35 U.S.C. §119 to Korean Patent Application No. 10-2012-0151056, filed on Dec. 21, 2012, in the Korean Intellectual Property Office, the entire contents of which are hereby incorporated by reference.

### BACKGROUND OF THE INVENTION

Example embodiments of the inventive concept relate to an optical receiver module, and in particular, to an optical receiver module including a flexible printed circuit board formed by a simple process without a step of forming a via hole.

Recently, communication, broadcast, and internet platforms are being converged under the information communication environment based on a fixed-mobile convergence technology, and, thus, a broadband network technology is being actively developed. Accordingly, there is an increasing interest in an optical communication technology. However, the optical communication technology suffers from high cost of an optical receiver module.

An optical receiver module based on a wavelength division multiplexing (WDM) technology includes a transmission line with N channels. The transmission line may be provided in a form of connector or printed circuit. The connector has several technical advantages, compared with the printed circuit, but there is a difficulty in integrating the connector. Accordingly, a high speed WDM optical receiver module is realized using a transmission line provided in a form of the printed circuit.

A flexible printed circuit (FPC) is one of the printed circuits and is realized using a flexible heat-resistant synthetic resin film, such as a polyester or polyimide. Since the FPC has flexibility, it can be used to form a relatively free electric connection. The FPC is electrically connected to an external circuit through a solder. To connect the FPC to the external circuit, there is a necessity to remove a portion of an external cover layer of the FPC or to form a via hole through the external cover layer.

However, the formation of the via hole or the removal of the external cover layer may lead to technical problems, such as a change in signal output characteristics of the FPC. In addition, the formation of the via hole may lead to an increase in complexity and cost of the fabrication process.

### SUMMARY

Example embodiments of the inventive concept provide an optical receiver module including a flexible printed circuit board that is formed by a simple process without a step of forming a via hole.

According to example embodiments of the inventive concepts, an optical receiver module based on a wavelength division multiplexing (WDM) technology may include a demultiplexer routing a plurality of multiplexed optical signals to different optical paths depending on their wavelengths, an optical device including a mirror and a plurality of lenses.

The mirror may be configured to reflect the optical signals, which are separated by the demultiplexer and are propagated along a horizontal direction, toward a vertical direction, and the lenses may be configured in such a way that the optical signals to be reflected from the mirror transmit therethrough. The module may further include a plurality of photodetectors provided spaced apart from the lenses to convert the optical signals transmitted from the lenses into electric signals, respectively, and a flexible printed circuit board configured to transmit the electric signals converted by the photodetectors to an external circuit. The plurality of the lenses and the plurality of the photodetectors may be fabricated in a form of a single array, and the flexible printed circuit board may include a first electrode layer for transmitting the electric signals to the external circuit and a second electrode layer for supplying a ground potential. The first and second electrode layers may be provided in a form of a microstrip line, and the flexible printed circuit board may have a via-hole-free structure.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a perspective view illustrating an optical receiver module according to example embodiments of the inventive concept.

FIG. 2 is a sectional view of the optical receiver module that is taken along line X-X′ of FIG. 1.

FIG. 3 is a perspective view illustrating a flexible printed circuit board of an optical receiver module according to example embodiments of the inventive concept.

FIG. 4 is a sectional view of a flexible printed circuit board having a conventional via hole structure.

FIG. 5 is a sectional view of a flexible printed circuit board according to example embodiments of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

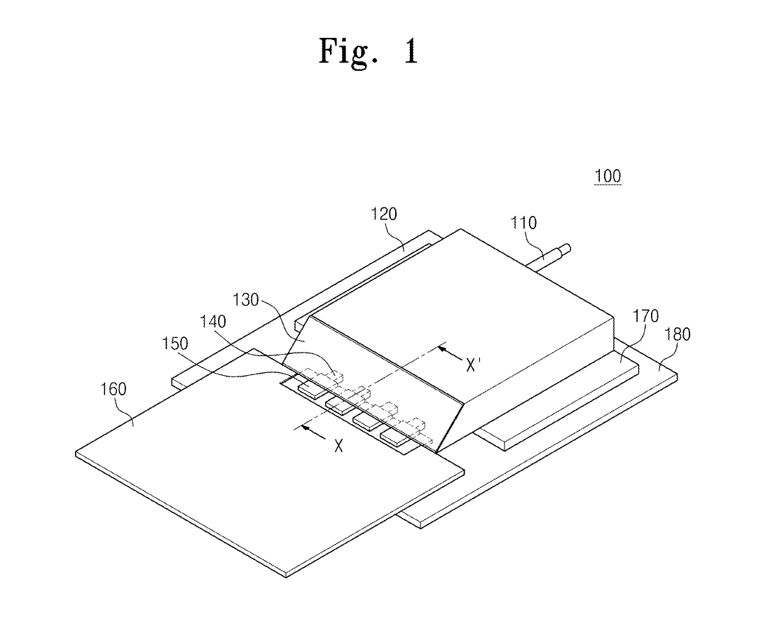

FIG. 1 is a perspective view illustrating an optical receiver module according to example embodiments of the inventive concept. Referring to FIG. 1, an optical receiver module 100 may include an optical connector 110, a demultiplexer 120, an optical device 130, a photodetector 140, a pre-amplifier 150, a flexible printed circuit board 160, a first supporting part 170, and a second supporting part 180. The optical receiver module 100 may be configured to transmit signals with several wavelengths through a single optical fiber. For example, the optical receiver module 100 may be operated using a wavelength-division-multiplexing (WDM) technology.

A conventional optical receiver module may be electrically connected to an external circuit through a solder to send optical signals to the external circuit. For example, a printed circuit board of the optical receiver module may be electrically connected to the external circuit through the solder. The solder may refer to a soldering alloy used for connecting devices to each other electrically. To connect the optical receiver module to the external circuit, it is necessary to remove a portion of an outer cover layer of the printed circuit board or form a via hole therein. However, this may lead to problems, such as a change in output characteristic of an electric signal and an increase of the overall fabrication cost.

According to example embodiments of the inventive concept, the optical receiver module 100 may be electrically connected to the external circuit by modifying a structure of an electrode layer of the flexible printed circuit board, not by removing partially the outer cover layer of the printed circuit board or forming the via hole.

The optical connector 110 may be configured to receive optical signals transmitted through from one optical fiber and transmit them to the demultiplexer 120. Here, the optical signals may include multichannel optical signals that have different wavelengths from each other and that are transmitted to the optical connector 110 through one optical fiber. The optical connector 110 may serve as a connecting portion for transmitting the multichannel optical signals to the demultiplexer 120.

The demultiplexer 120 may receive the multichannel optical signals transmitted through the optical connector 110. The demultiplexer 120 may be configured to route the multichannel optical signals transmitted through the optical connector 110 to different optical paths depending on their wavelengths. For example, the demultiplexer 120 may be configured to separate the multichannel optical signals into individual optical signals and send the separate optical signals to the optical device 130.

In example embodiments, the optical device 130 and the demultiplexer 120 may be provided in a form of an engaged or coupled structure. In other embodiments, the optical device 130 may be provided to be separated from the demultiplexer 120. The optical device 130 may be configured to receive each of the separate optical signals, which may be transmitted from the demultiplexer 120 along a horizontal direction, and transmit them to the photodetector 140.

In more detail, the optical device 130 may include a mirror and/or a lens. The mirror may be provided on a side surface of the optical device 130. For example, the mirror may be formed by coating the side surface of the optical device 130 with a reflective material. Due to the presence of the mirror, the separate optical signals transmitted from the demultiplexer 120 along the horizontal direction may be reflected, for example, at a right angle and be sent to the photodetector 140 through the lens.

The photodetector 140 may be provided spaced apart from the optical device 130 and be configured to receive the separate optical signals transmitted through the optical device 130. The photodetector 140 may convert the separate optical signals to electric signals. The photodetector 140 may be provided in the form of surface-illuminated type or waveguide type. The photodetector 140 may transmit the electric signals, which are converted from the separate optical signals, to the pre-amplifier 150.

The pre-amplifier 150 may be electrically connected to the photodetector 140 to amplify the electric signals transmitted from the photodetector 140. The pre-amplifier 150 may transmit the amplified electric signals to the flexible printed circuit board 160. In addition, the pre-amplifier 150 may be coupled to the photodetector 140 in a one-to-one manner, to amplify the electric signals according to respective channels.

The flexible printed circuit board 160 may deliver the electric signals amplified by the pre-amplifier 150 to the external circuit. The flexible printed circuit board 160 may be formed to have flexibility. The electric connection between the optical receiver module 100 and the external circuit may be achieved not by removing a portion of the flexible printed circuit board 160 or forming a via hole. In other words, by modifying a structure of the upper electrode layer and the lower electrode layer in the flexible printed circuit board 160, the flexible printed circuit board 160 may be electrically connected to the external circuit.

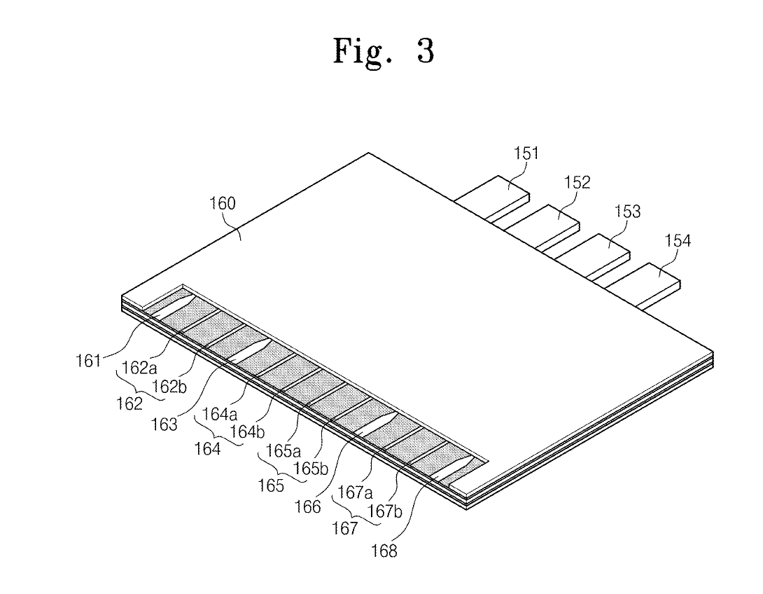

Since the flexible printed circuit board 160 is formed without a step of forming a via hole, it is possible to reduce overall cost for fabricating the optical receiver module 100. The flexible printed circuit board 160 will be described in more detail with reference to FIGS. 3 through 5.

The first and second supporting parts 170 and 180 may be configured to support the optical receiver module 100. For example, the first supporting part 170 may be provided below the demultiplexer 120 to support the demultiplexer 120, and the second supporting part 180 may be provided below the first supporting part 170 to support the whole structure of the optical receiver module 100.

As described above, the optical receiver module 100 may include the flexible printed circuit board 160 that is fabricated without a step of forming a via hole. Accordingly, the optical receiver module 100 may have a reduced size, compared to the conventional optical receiver module. For all that, output characteristics of electric signals to be transmitted through the transmission line of the flexible printed circuit board 160 may not be changed.

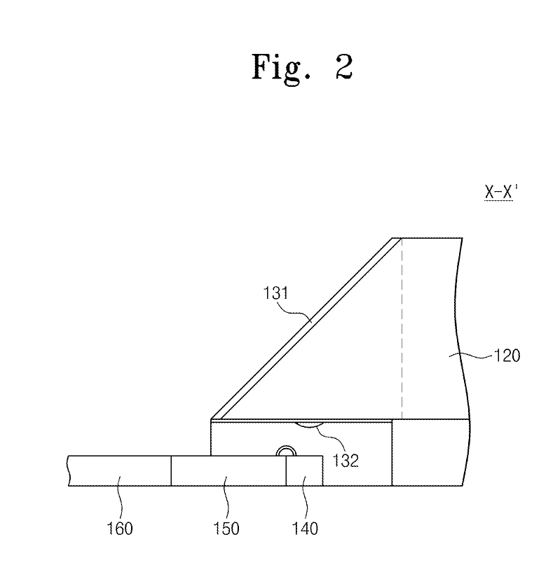

FIG. 2 is a sectional view of the optical receiver module that is taken along line X-X′ of FIG. 1.

Referring to FIG. 2, an optical signal transmitted through the demultiplexer 120 may be delivered to the photodetector 140 through the optical device 130. For example, the optical device 130 may include a mirror 131 and a lens 132 that are configured to deliver the optical signal to the photodetector 140. To process multichannel optical signals, the optical device 130 may include a plurality of the mirrors 131 and a plurality of the lenses 132.

The mirror 131 may be coated on a side surface of the optical device 130 that is at an angle of 45° to a top surface of the photodetector 140. Due to the presence of the mirror 131, the separate optical signals transmitted from the demultiplexer 120 along the horizontal direction may be reflected, for example, at a right angle and be sent to the lens 132.

The lens 132 may be provided on a surface of the optical device 130 located on a propagation path of the optical signal to be reflected by the mirror 131. In other words, the optical signal vertically reflected from the mirror 131 may be delivered to the photodetector 140 through the lens 132. The photodetector 140 may be configured to deliver the optical signal transmitted from the optical device 130 to the pre-amplifier 150.

FIG. 3 is a perspective view illustrating a flexible printed circuit board of an optical receiver module according to example embodiments of the inventive concept. Referring to FIG. 3, the flexible printed circuit board 160 may include first to fourth channel transmission lines 162, 164, 165, and 167 that are configured to route the electric signals, which are transmitted from the pre-amplifier, to the external circuit. In example embodiments, the flexible printed circuit board 160 may be electrically connected to the external circuit, without the use of any via hole.

The number of the transmission lines may be given depending on the number of optical signals to be input into the demultiplexer 120. For example, the flexible printed circuit board 160 may be configured to have two transmission lines for each channel of the optical signal. For instance, if optical signals with four channels are incident into the demultiplexer 120, the flexible printed circuit board 160 may include the first to fourth channel transmission lines 162, 164, 165, and 167, each of which include two transmission lines for each channel, as shown in FIG. 3. However, example embodiments of the inventive concepts may not be limited thereto, and for example, one transmission line may be provided for each channel of the optical signal.

Further, first to fourth electrode parts 161, 163, 166, and 168 may be provided in the flexible printed circuit board 160. The first to fourth electrode parts 161, 163, 166, and 168 may be configured to supply electric power that is required to send an electric signal to the external circuit through the transmission line. However, example embodiments of the inventive concepts may not be limited to the specific number of the electrode parts. For example, the number of the electrode parts may be modified depending on a process of fabricating the flexible printed circuit board 160.

The first channel transmission line 162 may include a first transmission line 162a and a second transmission line 162b receiving a first electric signal and a second electric signal, respectively, that are transmitted from a first pre-amplifier 151. Here, the first electric signal may be amplified by the first pre-amplifier 151 and be transmitted to the external circuit through the first transmission line 162a. The second electric signal may be a differential signal with inverted phase, compared to the first electric signal, and be transmitted to the external circuit through the second transmission line 162b.

The second channel transmission line 164 may include a third transmission line 164a and a fourth transmission line 164b receiving a third electric signal and a fourth electric signal, respectively, that are transmitted from a second pre-amplifier 152. Similar to the first and second electric signals, the third electric signal may be amplified by the second pre-amplifier 152, and the fourth electric signal may be a differential signal with inverted phase, compared to the third electric signal.

The third channel transmission line 165 may include a fifth transmission line 165a and a sixth transmission line 165b receiving a fifth electric signal and a sixth electric signal, respectively, that are transmitted from a third pre-amplifier 153. The fifth electric signal may be amplified by the third pre-amplifier 153, and the sixth electric signal may be a differential signal with inverted phase, compared to the fifth electric signal.

The fourth channel transmission line 167 may include a seventh transmission line 167a and an eighth transmission line 167b receiving a seventh electric signal and an eighth electric signal, respectively, that are transmitted from a fourth pre-amplifier 154. The seventh electric signal may be amplified by the fourth pre-amplifier 154, and the eighth electric signal may be a differential signal with inverted phase, compared to the seventh electric signal.

Further, the conventional flexible printed circuit board may include two electrode layers, each of which is configured to have a ground line. In the conventional flexible printed circuit board, it is necessary to form a via hole for connecting the ground lines on the two electrode layers to each other. However, due to its complexity, the process of forming the via hole may lead to an increase in the overall cost of the optical receiver module.

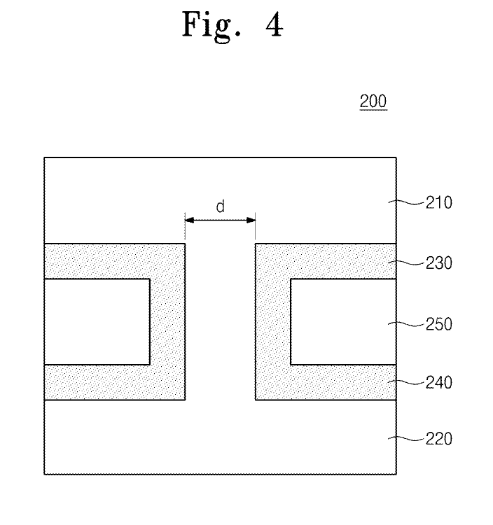

FIG. 4 is a sectional view of a flexible printed circuit board having a conventional via hole structure.

Referring to FIG. 4, a flexible printed circuit board 200 may include an upper cover layer 210, a lower cover layer 220, an upper electrode layer 230, a lower electrode layer 240, and an insulating layer 250.

In the flexible printed circuit board 200 of FIG. 4, a plurality of channel transmission lines (not shown) and a ground line (not shown) may be realized using the upper electrode layer 230. To connect the ground line on the upper electrode layer 230 with a ground line (not shown) on the lower electrode layer 240, a via hole with a distance d may be formed through the flexible printed circuit board 200. Due to the presence of the via hole with the distance d, each or all of the upper electrode layer 210, the lower electrode layer 220, and the insulating layer 250 may be partially cut. Thereafter, a complex wiring process may be further performed to connect the upper electrode layer 210 to the lower electrode layer 220. For example, the cut portion may be plated with a conductive material (e.g., the same metal as that of the electrode layers 210 and 220).

Further, the flexible printed circuit board 200 with the via hole may be electrically connected to the external circuit through the lower electrode layer 240. Accordingly, for an electric connection with the external circuit, a portion of the lower cover layer 250 should be removed by an additional process. In other words, due to the presence of the via hole, a fabrication process of the conventional flexible printed circuit board 200 may become complex, and this leads to an increase of fabrication cost.

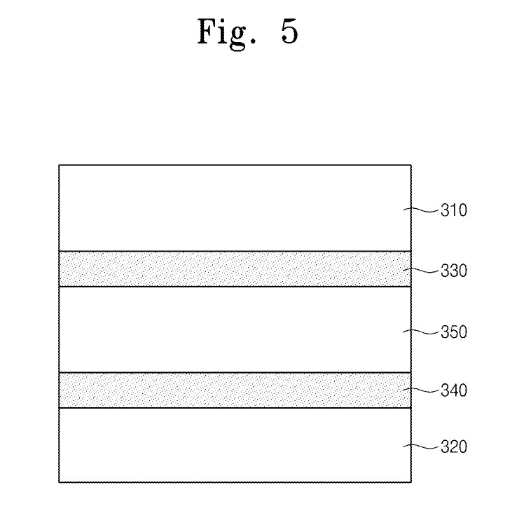

FIG. 5 is a sectional view of a flexible printed circuit board according to example embodiments of the inventive concept.

Referring to FIG. 5, a flexible printed circuit board 300 may include an upper cover layer 310, a lower cover layer 320, an upper electrode layer 330, a lower electrode layer 340, and an insulating layer 350.

The flexible printed circuit board 300 may be fabricated to have a microstrip line structure, and thus, it can be fabricated without the process of forming a via hole. The microstrip line may include a channel transmission line provided on one of the electrode layers and a ground line provided on the other of the electrode layers. Here, since the channel transmission line is provided on one electrode layer of the microstrip line, there is no necessary to form a via hole for electric connection between ground lines. Accordingly, the flexible printed circuit board 300 may be electrically connected to the external circuit, without the use of the via hole.

For example, the upper cover layer 310 may be provided on the upper electrode layer 330 to prevent the upper electrode layer 330 from being exposed to and insulated from the outside. The lower cover layer 320 may be provided below the lower electrode layer 340 to prevent the lower electrode layer 340 from being exposed to and insulated from the outside.

The first to fourth channel transmission line 162, 164, 165, and 167 may be provided in the upper electrode layer 330 below the upper cover layer 310 to transmit electric signals to the external circuit. For example, the ground line for a grounding connection with the lower electrode layer 340 may not be provided in the upper electrode layer 330. In other words, the first to fourth channel transmission line 162, 164, 165, and 167 for supplying electric signals to the external circuit and the first to fourth electrode parts 161, 163, 166, and 168 for supplying an electric power may be provided on the upper electrode layer 330.

The upper cover layer 310 and the lower cover layer 320 may be formed of a dielectric layer, such as polyimide, but example embodiments of the inventive concept may not be limited thereto. The upper cover layer 310 may be patterned or partially removed by an etching process to connect the upper electrode layer 330 with the pre-amplifier or the external circuit. Further, the lower cover layer 320 may be patterned or partially removed by an etching process to connect the lower electrode layer 340 with the pre-amplifier or the external circuit.

The ground line (not shown) may be provided on the lower electrode layer 340, thereby supplying a ground potential to the device. The upper and lower electrode layer 330 and 350 may be formed of a conductive metal (e.g., copper), but example embodiments of the inventive concept may not be limited thereto. Since the upper electrode layer 330 is electrically connected to the external circuit, there is no necessary to remove a portion of the lower cover layer 320.

The insulating layer 350 may be configured to prevent the upper electrode layer 330 and the lower electrode layer 340 from being in contact with each other. The insulating layer 350 may be formed of a dielectric layer (e.g., polyimide), but example embodiments of the inventive concept may not be limited thereto.

According to example embodiments of the inventive concept, the flexible printed circuit board 300 may be electrically connected to the external circuit, without any use of the via hole shown in FIG. 4. Accordingly, it is possible to simplify a process of fabricating a optical receiver module and reduce a fabrication cost.

According to example embodiments of the inventive concept, the optical receiver module may include a flexible printed circuit board, which can be formed without a step of forming a via hole. Accordingly, an overall process of fabricating the optical receiver module can be simplified, and thus, it is possible to increase efficiency of mass production and reduce a fabrication cost.

While example embodiments of the inventive concepts have been particularly shown and described, it will be understood by one of ordinary skill in the art that variations in form and detail may be made therein without departing from the spirit and scope of the attached claims.

What is claimed is:

1. An optical receiver module based on a wavelength division multiplexing (WDM) technology, comprising:
a demultiplexer routing a plurality of multiplexed optical signals to different optical paths depending on their wavelengths;
an optical device including a mirror and a plurality of lenses, wherein the mirror is configured to reflect the optical signals, which are separated by the demultiplexer and are propagated along a horizontal direction, toward a vertical direction, and the lenses are configured in such a way that the optical signals to be reflected from the mirror transmit therethrough;
a plurality of photodetectors provided spaced apart from the lenses to convert the optical signals transmitted from the lenses into electric signals, respectively; and
a flexible printed circuit board configured to transmit the electric signals converted by the photodetectors to an external circuit,
wherein the plurality of the lenses and the plurality of the photodetectors are fabricated in a form of a single array,
the flexible printed circuit board comprises a first electrode layer for transmitting the electric signals to the external circuit and a second electrode layer for supplying a ground potential, and
the first and second electrode layers are provided in a form of a microstrip line, and the flexible printed circuit board has a via-hole-free structure.

2. The optical receiver module of claim 1, further comprising, a pre-amplifier electrically connected to the plurality of the photodetectors to amplify intensities of the electric signals transmitted from the plurality of the photodetectors.

3. The optical receiver module of claim 2, wherein the pre-amplifier is electrically connected to the flexible printed circuit board to transmit the amplified electric signals to the flexible printed circuit board.

4. The optical receiver module of claim 1, wherein the flexible printed circuit board comprises:
a first cover layer provided on the first electrode layer to isolate the first electrode layer electrically from the outside;
a second cover layer provided under the second electrode layer to isolate the second electrode layer electrically from the outside; and
an insulating layer provided between the first electrode layer and the second electrode layer to separate the first and second electrode layers electrically from each other.

5. The optical receiver module of claim 4, wherein the first electrode layer is configured to include a plurality of channel transmission lines for transmitting the electric signals to the external circuit, and the second electrode layer is configured to include a ground line for supplying a ground potential.

6. The optical receiver module of claim 5, wherein the channel transmission lines are electrically connected to the external circuit to transmit the electric signals to the external circuit.

7. The optical receiver module of claim 4, wherein the first and second electrode layers comprises patterns formed by a wet etching process.

8. The optical receiver module of claim 4, wherein the first cover layer is provided to have a partially-removed structure, thereby allowing the first electrode layer to be electrically connected to the external circuit.

9. The optical receiver module of claim 1, wherein the first electrode layer is configured in such a way that a pattern of an electrode part for supplying an electric power to the flexible printed circuit board is formed therein.

10. The optical receiver module of claim 1, further comprising an optical connector configured to transmit the optical signals, which are transmitted from one optical fiber, to the demultiplexer.
